(19) United States
(12) Patent Application Publication
(10) Pub. No.: US 2006/0061313 A1
(43) Pub. Date: Mar. 23, 2006

(54) Ventilation system for a garage

(76) Inventors: James J. Fitzgibbon, Batavia, IL (US); Mark L. Karasek, Lombard, IL (US); David T. Mack, Naperville, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/241,126

(22) Filed: Sep. 30, 2005

(51) Int. Cl. H02P 1/00

(52) U.S. Cl. 318/452

(57) ABSTRACT

A power ventilation system comprising an exhaust fan, a power supply, and a control system is provided for ventilation of a garage. The ventilation system may be controlled by a moveable barrier, interfaced to a weather seal of the garage door, or configured to allow power ventilation of the garage when the garage door is closed.

### FIELD OF THE INVENTION

This invention relates generally to the concept of ventilation of the garage and more specifically to the operation of a power ventilation system, which is controlled by a movable barrier operator.

### BACKGROUND OF THE INVENTION

Modern garages are designed with some form of passive ventilation. Methods used in present construction technology include ridge ventilation and roof ventilation usually in combination with soffit ventilation.

These techniques of ventilation are used in order to protect the roof and attic from the environmental hazards of heat and moisture buildup. They do nothing to eliminate the fumes and odor which usually exists in the garage. This invention removes the fumes and odors that are present in the garage.

### SUMMARY OF THE INVENTION

One aspect of the invention is to provide a power ventilation system used to eliminate or reduce the fumes and odors created within the garage. A second aspect of this invention is to provide control of the power ventilation system so that this reduction of fumes and odors occurs when it is needed, rather than continuously operating.

In one embodiment of the present invention, a standard power ventilation system is controlled by the movable barrier operator. In another embodiment, the ventilation system is interfaced to the weather seal for the garage door for a system that is easier to install system and is controlled by the movable barrier operator. In a third embodiment the door is modified in order to allow for the power ventilation of the garage when the barrier is closed.

### BRIEF DESCRIPTION OF THE DRAWINGS

FIG. 1 illustrates the prior art ridge ventilation with soffit vents.

FIG. 2 illustrates the prior art roof ventilation with soffit vents.

FIG. 3 illustrates the prior art roof ventilation with soffit vents and the effects of the ceiling being drywalled.

FIG. 4 illustrates an inside view of the garage with a power vent fan.

FIG. 5 illustrates an exhaust fan mounted to the side of the garage.

FIG. 6 illustrates an exhaust fan ducted to a standard garage vent.

FIG. 7 illustrates a weather seal.

FIG. 8 illustrates detail of the weather seal acting as a duct.

FIG. 9 illustrates ports added to the garage door.

FIG. 10 illustrates a method of coupling the stationary fan to the movable door.

### DETAILED DESCRIPTION OF THE INVENTION

A filler understanding of the invention will be accomplished from the following explanation of a number of embodiments of the present invention.

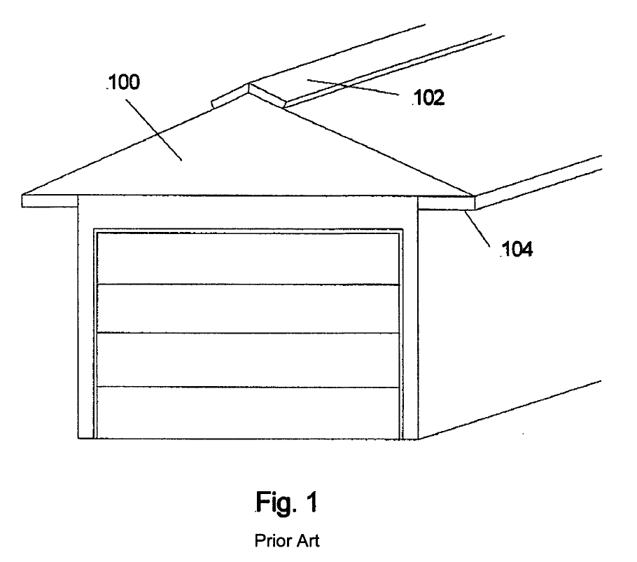

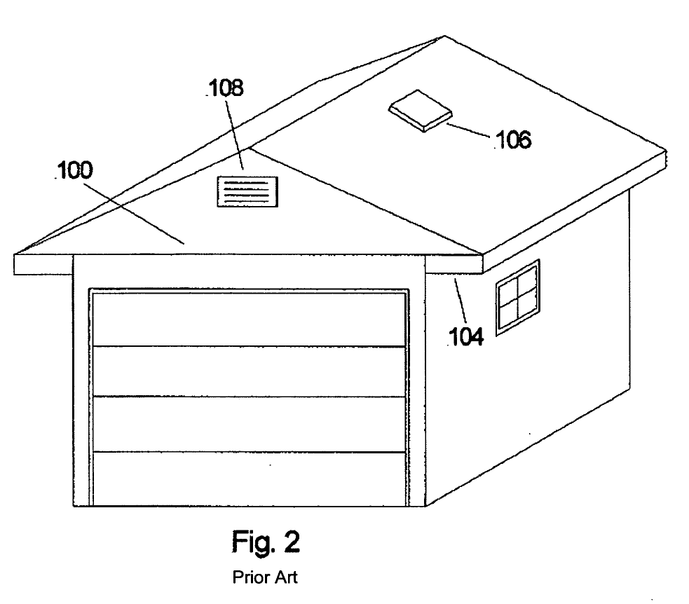

FIG. 1 is one representation of the present state of the art in ventilation of a garage. The garage 100 has ridge ventilation and soffit ventilation. Air usually flows in through the soffit vents 104 and out through the ridge vents 102. This air flow allows the attic space to remain cooler and drier extending the life of the roof. This system of air flow is also accomplished in the system illustrated in FIG. 2. In FIG. 2, the ridge vent is replaced by either attic vent 106 or face vent 108. Again the usual air flow is from the soffit 104 to the vent.

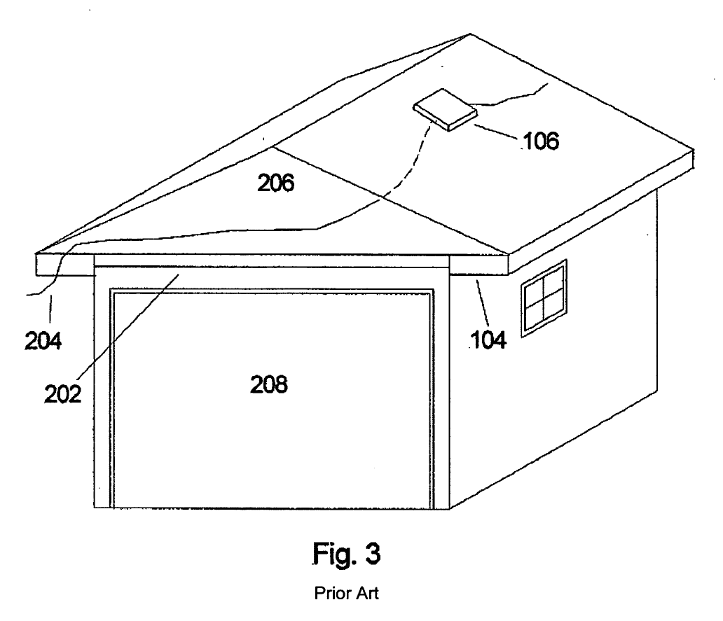

Current garage ventilation systems do not remove fumes and odor which exist at ground level of the floor. In fact, as garage technology has progressed, the use of drywalled ceilings has increased, increasing the trapping of the fumes within the garage. In FIG. 3, a basic cutaway view removes the garage's front exterior face, and shows the drywall 202 restricting the air flow 204 from passing through occupation area 208. Instead, the airflow passes from the soffit 104 through the attic 206 and out the roof vent 106. This does nothing to remove fumes and odor from the occupation area 208.

The fumes and odor are generated by items usually stored within the garage. Many homeowners keep their garbage within the garage until it is time to be picked up in order to protect it from pests and varmints. The garbage can create a very unpleasant odor and stays within the garage. Paint, gasoline, and oil are also usually stored within the garage. Properly sealed they would not be a problem, but usually they are not properly sealed and, therefore, create fumes and odors within the garage. The family vehicle can also be a great creator of fumes and odors within the garage. The vehicle not only produces dangerous fumes while running, but also has a tendency to release those fumes after being parked within the garage. These fumes not only create a problem when the owners of the home enter the garage but also have the possibility of seeping into the home through the access door or, if there are rooms above the garage, through the floor of the room.

Ideally in order to remove these fumes a system would be set up to exhaust them from the area when needed. This can be accomplished using a power exhaust fan.

In general the garage is used as a passageway from the house and to access at least one vehicle. In order to move the vehicle or to exit the garage the garage door must be moved. Movement of the garage door can be detected either by a movable barrier operator in the form of a garage door operator or any other form of detection device. For illustration purposes, the detection device use herein is a garage door operator but, of course, other methods such as a switch and optical detector ultrasonic detector etc. could be used.

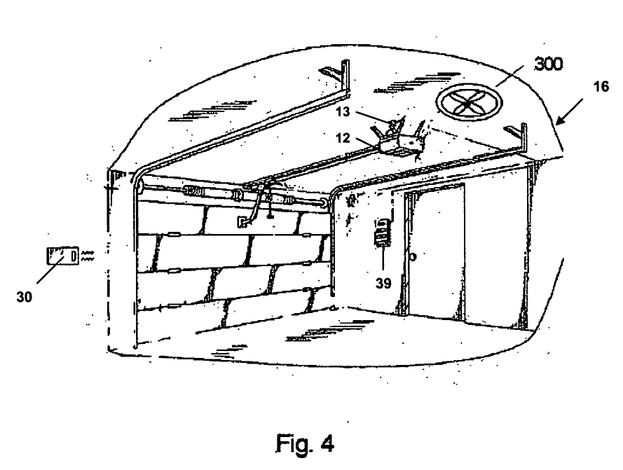

FIG. 4 shows an inside view of garage 16. Within the garage 16 is a movable barrier operator 12. The operation of a movable barrier operator is well known in the art. The movable barrier operator 12 is in communication with an exhaust fan 300. The exhaust fan 300 can either be powered by the movable barrier operator 12, or it can be powered from the outlet 13 and controlled via the communications to the movable barrier operator 12.

The communications between the movable barrier operator 12 and the exhaust fan 300 can be performed by wires or wirelessly. When performed by wires, the communications can be as simple as the movable barrier operator 12 applying power to the exhaust fan 300. When the communications contains a data stream conveyed either by wire or wirelessly, a data stream can contain instructions to the fan or status information from the movable barrier operator. If the data stream contains instructions, the instructions can be on or off, or speed and time of operation information. If the data stream is the status information from the movable barrier operator, the exhaust fan can make a decision as to how to operate. No matter how the system is partitioned, a control system is created between the movable barrier operator 12 and the exhaust fan 300.

Whenever the decision as to how to operate is being performed, the decision would be made intelligently according to the sequence of operations. Referring again to FIG. 4, the movable barrier operator 12 has more than one method of being activated. A wall control 39 is shown next to the access door to the garage. External to the garage, a transmitter 30 is also shown. If the movable barrier operator 12 is first activated by wall control 39 and then closed by transmitter 30, the control system will assume that the homeowner has left the garage and, therefore, can either minimize the amount of time which exhaust fan 300 is activated or not activated it at all. If the sequence is reversed and the door is opened via transmitter 30 and closed by wall control 39, the control system can assume that a vehicle has been placed within the garage and can, therefore, activate the exhaust fan 300 for a longer period of time or delay activation waiting for the exhaust fumes to seep out of the vehicle's exhaust. For each of the potential sequences of operation of the movable barrier operator 12 the control system includes appropriate activation instructions.

The exhaust fan may have a number of physical locations. FIG. 4 shows one embodiment. In a garage where the ceiling has been drywalled, the fan only needs to be placed into the drywall similar to a whole house ventilation fan or a bathroom fan. When the fan is activated, the air from the garage is pulled into the attic and forced through the attic ventilation system.

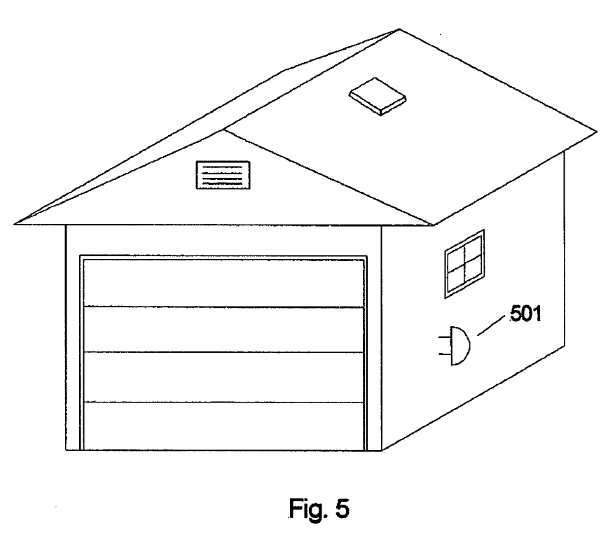

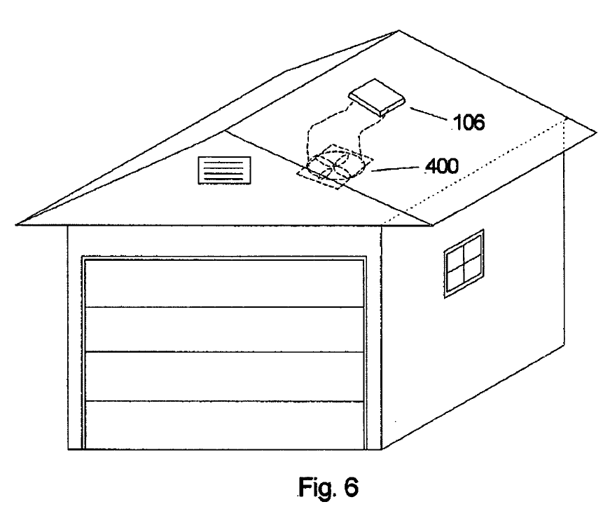

FIG. 5 shows another embodiment of the system. In FIG. 5, the exhaust fan 501 is mounted to the side of the garage. FIG. 6 shows yet another embodiment in which the exhaust fan 400 is ducted to the outside world through one of the standard vents 106 of the garage. This allows the exhaust fan 400 to be mounted without concerns for creating holes in the building.

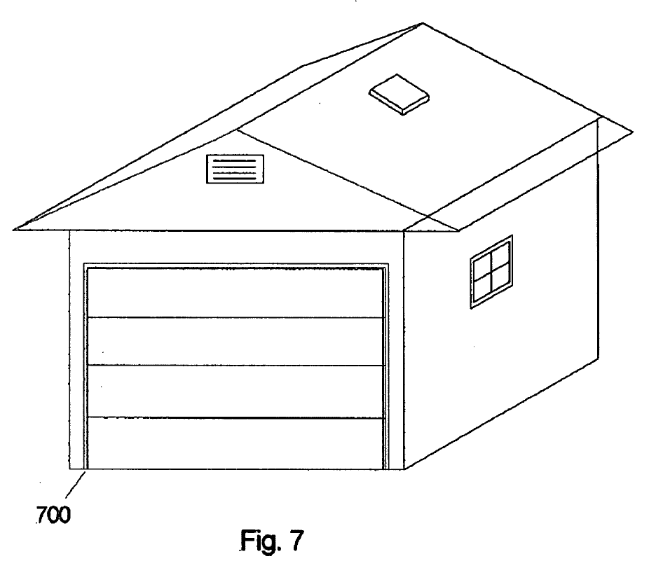

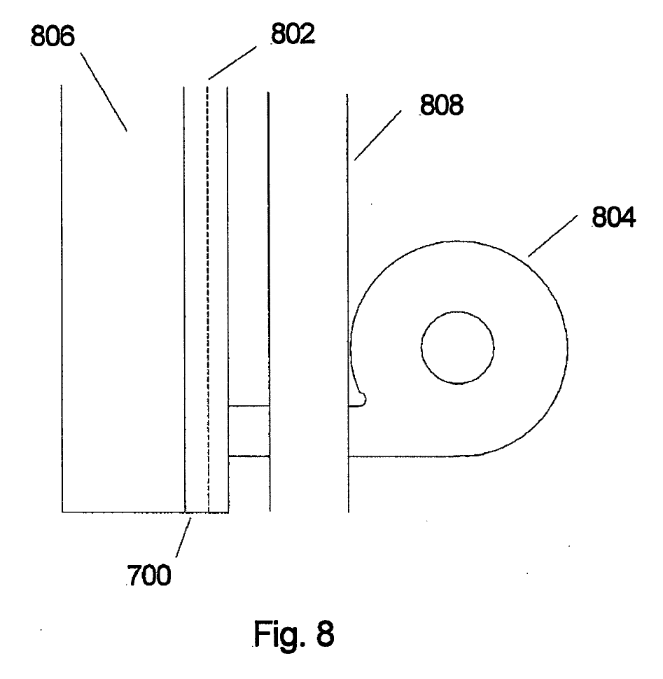

Yet another advantage of the present invention occurs when the exhaust fan becomes integrated with the barrier itself. As shown in FIG. 7, in one embodiment the weather seal 700 for the barrier becomes the duct which carries the exhaust air to the outside world. FIG. 8 is a detailed drawing of a small section of FIG. 7 showing the exhaust fan 804 and the vents 802 in the weather seal 700. The air moves from the exhaust fan 804 through a duct into the weather seal 700. The weather seal 700 contains one or more vents 802. The vent or vents 802 permit the air to exit the garage.

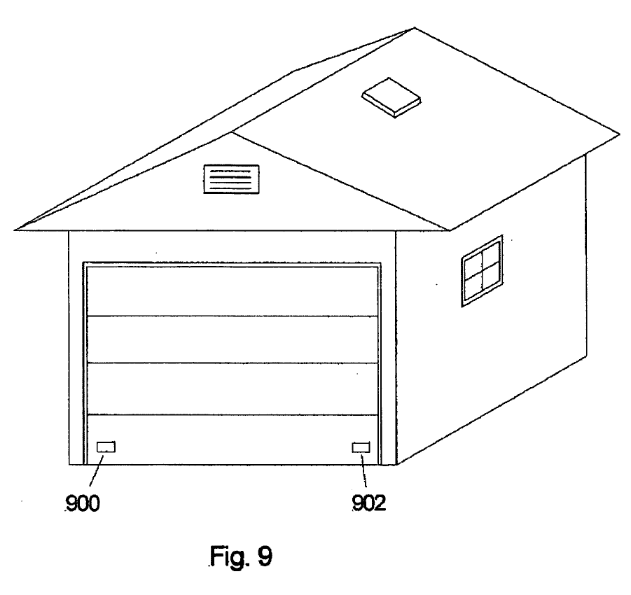

An integrated system could also be accomplished using a port or ports built into the garage door or bottom weather seal as shown in FIG. 9. Port 900 allows the air to be forced out of the garage. The port 900 can have a flap door in the front to keep pests from entering the garage through the port. The system may include a second port 902. Port 902 may be connected to a second exhaust fan or may be ducted to the first exhaust fan.

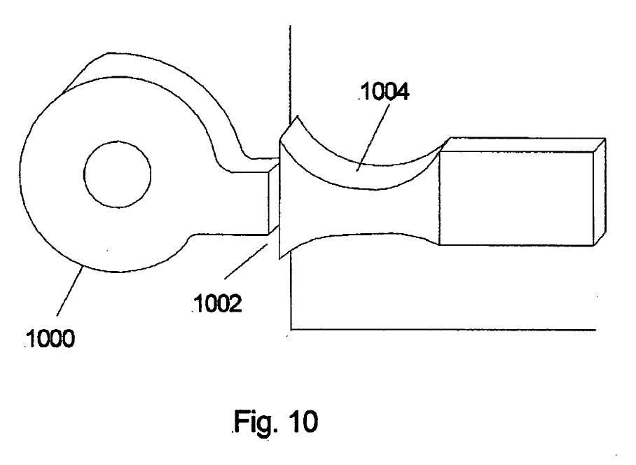

In order too allow the door to open and create an air flow into the port, the fan must be coupled to the port. An example of this coupling is shown in FIG. 10. In FIG. 10, a duct 1004 is coupled to the fan 1000 through an open coupling 1002. The open coupling 1002 could be replaced with a flexible hood flap or any other connection which would allow the motion of the door yet still have the fan coupled to the barrier when the barrier is closed.

In another embodiment, the port could be replaced with the weather seal at the bottom of the door. The weather seal could be vented similar to the venting shown in FIGS. 7 and 8.

What is claimed is:

1. A power ventilation system for a garage comprising:
an exhaust fan;
a power supply for powering the exhaust fan; and
a control system for controlling the operation of the exhaust fan.

2. The power ventilation system of claim 1 further comprising a moveable barrier operator, wherein the power ventilation system is at least partially controlled according to the operation of the movable barrier operator.

3. The power ventilation system of claim 1 further comprising a duct for coupling the power ventilation system to a barrier.

4. The power ventilation system of claim 1 further comprising a barrier with a weather seal, wherein the power ventilation system is built into the weather seal.
